(19) United States
(12) Patent Application Publication
(10) Pub. No.: US 2025/0163282 A1
(43) Pub. Date: May 22, 2025

(54) PREPARATION TECHNOLOGY OF MODIFIED POLYAMIDE WAX FOR COATING AND A COATING FORMED

(71) Applicant: ZHEJIANG FENGHONG NEW MATERIALS CO., LTD, Huzhou (CN)

(72) Inventors: Jun LUO, Huzhou (CN); Jinling LIU, Huzhou (CN); Tianyu JIANG, Huzhou (CN); Qi HUA, Huzhou (CN); Guokai CUI, Huzhou (CN); Lin XU, Huzhou (CN); Pengjun ZHANG, Huzhou (CN); Chengfeng LI, Huzhou (CN); Jingjing LI, Huzhou (CN); Hong SUN, Huzhou (CN); Zexiong ZHOU, Huzhou (CN)

(73) Assignee: ZHEJIANG FENGHONG NEW MATERIALS CO., LTD, Huzhou (CN)

(21) Appl. No.: 19/007,788

(22) Filed: Jan. 2, 2025

Related U.S. Application Data
(63) Continuation of application No. PCT/CN2022/132402, filed on Nov. 17, 2022.

(30) Foreign Application Priority Data
May 6, 2022 (CN) 202210484823.0

(51) Int. Cl. C09D 7/65; B01F 27/192; B01F 27/72; B01F 27/806; B01F 27/81; B01F 27/906; B01F 35/75; B01F 35/90; C09D 5/02; C09D 7/20; C09D 7/40; C09D 7/43; C09D 7/45; C09D 7/47; C09D 7/61; C09D 7/63; C09D 7/80; C09D 183/06

(52) U.S. Cl. CPC C09D 7/65; B01F 27/192; B01F 27/72; B01F 27/806; B01F 27/811; B01F 27/906; B01F 35/754551; B01F 35/7547; B01F 35/90; C09D 5/022; C09D 5/024; C09D 7/20; C09D 7/43; C09D 7/45; C09D 7/47; C09D 7/61; C09D 7/63; C09D 7/70; C09D 7/80; C09D 183/06; B01F 2035/98

(57) ABSTRACT

The invention relates to a preparation process of a modified polyamide wax for coatings and a formed coating. The coating includes 0.5-5 parts by weight of modified polyamide wax; the preparation process of the modified polyamide wax for coating includes the following steps: S1, ratio of raw materials:raw materials include water-based polyamide wax, water-based polyurethane, polyoxyethylene monostearate, the first composite modifier, organic amine, organic solvent, the second composite modifier, deionized water; S2, prepare the first complex; S3, add organic amine, organic solvent and the second composite modifier is evenly mixed, and the temperature is raised to 100-120° C. until the water-based polyamide wax is completely dissolved to obtain the first intermediate modifier; S4, deionized water is heated up and slowly added to the first intermediate modifier in the process. The coating system prepared by the invention has good leveling, stability and sag resistance.

### CROSS-REFERENCE TO RELATED APPLICATIONS

The application claims priority to Chinese patent application No. 202210484823.0, filed on May 6, 2022, the entire contents of which are incorporated herein by reference.

### TECHNICAL FIELD

The invention relates to the technical field of coatings, in particular to a preparation process of a modified polyamide wax for coatings and a formed coating.

### BACKGROUND

The main problems faced by water-based coatings are the low viscosity of the water-based resin system itself, easy sagging during construction, and easy sedimentation during storage. These require rheological additives to be adjusted to improve sag resistance and storage stability. Polyamide wax, which is usually used as a rheological additive, is an excellent thixotropic additive, which can better balance the anti-sag and leveling properties of the coating film, impart high thixotropic properties to the coating system, and has excellent thixotropic properties. Thickening and anti-settling effect can effectively prevent the sedimentation of pigments and fillers in coatings.

The base material of commercial grade water-based polyamide wax is usually obtained by polycondensation of dibasic acid and dibasic amine. Because the chain structure of polyamide wax itself is hydrophobic, it is difficult to disperse effectively in water-based coatings. In order to increase the hydrophilicity of the material, the polyamide wax material is generally given a higher acid value, which requires reducing the degree of polymerization of the polycondensation reaction during synthesis; this low molecular weight, high acid value material has excellent hydrophilic properties, very suitable for dispersion in aqueous systems. However, due to its low molecular weight, poor crystallization performance and unstable crystal structure, its anti-settling and anti-sag properties in the system are relatively poor.

Therefore, there is an urgent need in the industry for a polyamide wax that has both dispersion and anti-sinking and anti-sagging properties in coatings, and coatings containing this polyamide wax.

At the same time, the existing polyamide wax preparation device has low efficiency and is likely to pose a health threat to the operator.

### SUMMARY

The first technical purpose of the present invention is to provide a preparation process of the modified polyamide wax for coatings.

The second technical object of the present invention is to provide a paint formed from a modified polyamide wax for paint.

The first technical purpose of the present invention is achieved through the following technical solutions:

A preparation process of modified polyamide wax for coating, comprising the following steps:
S1, raw material ratio: the raw materials include water-based polyamide wax, water-based polyurethane, polyoxyethylene monostearate, the first composite modifier, organic amine, organic solvent, the second composite modifier, and deionized water;

The proportions of each component are:
20-30 parts of water-based polyamide wax;
3-5 parts of water-based polyurethane,
1-3 parts of polyoxyethylene monostearate,
1-3 parts of the first composite modifier,
4-6 parts of organic amines,
8-20 parts of organic solvent,
1-3 parts of the second composite modifier,
100 parts of deionized water;
S2, firstly mix and disperse water-based polyamide wax, water-based polyurethane, polyoxyethylene monostearate and the first composite modifier in proportion to obtain the first complex;
S3, adding an organic amine, an organic solvent and a second composite modifier to the first complex to mix uniformly, and the temperature is raised to 100-120° C. until the water-based polyamide wax is completely dissolved to obtain the first intermediate modifier;
S4, heating the deionized water, slowly adding it to the first intermediate modifier, controlling the stirring speed, and cooling to room temperature to obtain a modified polyamide wax for coating.

In the present invention, the first complex is formed by first physical compounding with the substance in step S2, and then chemical modification is performed in step S3 and solid content control in step S4 is performed, so as to prepare a coating which has both dispersibility and thermal stability and is capable of anti-settling and anti-sagging by using the modified polyamide wax.

Preferably, the first composite modifier includes water-based polyethylene wax, cellulose, xanthan gum and water-based bentonite mixed in a mass ratio of 4:3:2:1;

The second composite modifier includes polyetheramine and carbonamide mixed in a mass ratio of 1:1.

Generally speaking, water-based polyamide waxes with high solid content have poor dispersion performance and need to be added after pre-gel preparation, but their sag resistance is very good, and the orientation performance is relatively good; The water-based wax with low solid content and good dispersion performance has relatively average anti-sag performance. The higher the acid value of the polyamide resin, the better its hydrophilicity, which is more conducive to its dispersion in the water-based coating system; but the acid value is too high, which also means that its anti-settling and anti-sagging performance is weak.

The inventors found that by adding organic amine, organic solvent and second composite modifier to the first complex generated in step S2, the mixture is uniformly mixed and heated to react, which helps to simultaneously improve the dispersion of the modified polyamide wax for coatings. In addition, it is beneficial to control the solid content in step S4, and the modified polyamide wax with a solid content of about 15% can be prepared. This may be due to the formation of a block polymer model through the above proportioning and preparation process, segment modification of the modified polyamide wax for coatings, and the introduction of new functional groups, thereby improving its dispersibility, thermal stability and anti-sinking and anti-sagging.

More preferably, the second composite modifier further comprises 3-isocyanatomethylene-3,5,5-trimethylcyclohexylisocyanate, the 3-isocyanatomethylene-3,5,5-trimethylcyclohexylisocyanate to polyetheramine is 1:1.

The inventor found that adding 3-isocyanatomethylene-3,5,5-trimethylcyclohexylisocyanate to the second composite modifier can further improve the spatial network structure on the molecular chain of the polyamide rheological agent, thereby improving its dispersibility, thermal stability and anti-settling and anti-sagging properties.

Preferably, the organic amine is selected from one or more of fatty amines, alcohol amines, amides, and aromatic amines; the organic solvent is selected from one or more of propylene glycol monomethyl ether, propylene glycol monobutyl ether, dipropylene glycol methyl ether, and dipropylene glycol butyl ether.

Preferably, the preparation device of the modified polyamide wax for coating comprises a tower body, a up-and-down moving stirring mechanism, a secondary stirring mechanism, a cooling and conveying mechanism, a discharge valve, and a feeding port is provided on the top of the side wall of the tower body, the bottom of the tower body is provided with a discharge port, the discharge valve is set on the discharge port, the up-and-down moving stirring mechanism is set in the tower body, and the secondary stirring mechanism is set at the outlet of the discharge port, and the cooling and conveying mechanism is provided at the end of the secondary stirring mechanism.

The invention further improves the dispersibility, thermal stability and anti-settling and anti-sagging properties of the polyamide wax through a specific modified polyamide wax preparation device.

Preferably, the up-and-down moving stirring mechanism comprises a hydraulic push rod, a connecting rod, the fixed box with a hollow interior, a stirring motor, a driving gear, a driven gear, a stirring rod and a sealing bearing, the hydraulic push rod is located at the top of the tower body, the fixed box is fixedly connected with the push rod end of the hydraulic push rod, the stirring motor is arranged in the fixed box, the driving gear is located at the output shaft of the stirring motor, and the driven gear is meshed and connected with the driving gear, the described connecting rod passes through described driven gear and fixed box and is fixedly connected with driven gear, the upper surface of described fixed box is formed up to the lower surface and offers mounting hole, described sealing bearing is fixed on described mounting hole, the inner ring of described sealing bearing is fixedly connected with the outer side wall of described connecting rod, and described stirring rod is located on described connecting rod.

Preferably, the stirring rod includes a first stirring rod and a second stirring rod, the first stirring rod is located on the side wall of the connecting rod, and the second stirring rod is located at the bottom of the connecting rod, so the second stirring rods are evenly distributed in the axial direction of the connecting rods, and the first stirring rods are inclined downward by 10° to 15°, and the inclined angle is conducive to sufficient stirring.

Preferably, the interior of the connecting rod is a hollow structure, the interior of the second stirring rod is a hollow structure, the second stirring rod and the connecting rod communicate with each other, and the top of each second stirring rod is provided with a water outlet hole, the outer ring of the sealing bearing is fixedly connected with the water inlet telescopic tube, the other end of the water inlet telescopic tube extends to the outside of the tower body, and the water inlet telescopic tube can be a hose.

Preferably, an anti-blocking mechanism is provided on the water outlet hole, and the anti-blocking mechanism includes a plug core, a cover plate, a first compression spring, a limit rod, a limit block, and a limit ring, and the side openings are provided with oppositely arranged limit grooves, the cover plate is covered on the water outlet hole, the first compression spring is arranged at the bottom of the cover plate, the plug core is arranged at the bottom of the first compression spring, the bottom is located in the water outlet hole, the limit ring is set at the notch of the limit groove, the limit rod passes through the limit ring and is fixedly connected with the bottom of the cover plate, the limit block is located at the bottom of the limit rod, when deionized water is introduced into the tower body through the anti-blocking mechanism, deionized water ejects the plug core out of the water outlet hole through the water outlet hole, the water of removal enters into the first intermediate modifier substance through the water outlet hole, the limit rod on the cover plate is subject to the limit of the limit groove simultaneously, makes the cover plate can not be separated from the stirring rod, realizes the function of water outlet hole, when the deionized water is not required, stop the water inlet, compression spring pushes up the plug core, makes the plug core close the water outlet hole, and the cover plate closes the water outlet hole simultaneously, the first intermediate modifier is prevented from entering the outlet hole to affect the output of deionized water, and the stirring efficiency is improved.

Preferably, the cooling and conveying mechanism includes a first casing, a rotating shaft, a spiral blade, and a cooling coil, the rotating shaft is arranged in the first casing, and the spiral blade is wound on the rotating shaft, the cooling coil is wound on the outer side wall of the first casing, the product is transported through the spiral blade, and the product is cooled by passing cooling water into the cooling coil, so that the product reaches the standard.

Preferably, the water outlet end of the cooling coil is connected with a heating box through a pipeline, the outlet of the heating box is connected with a pump through a pipeline, the pump is a booster pump, the water outlet of the pump is connected with the water inlet telescopic tube through a pipeline, and the water outlet end is connected with the heating box through a pipeline.

Preferably, the secondary stirring mechanism comprises a second casing and a turning shaft that can be rotated in the second casing, the end of the turning shaft is fixedly connected with the starting end of the rotating shaft, the turning shaft comprises a conveying area and a mixing area from right to left, the conveying area is the main screw, a first ball socket groove is formed at the turning shaft of the mixing area, and the inside of the second casing is provided with a second ball socket groove that is matched with each other in the first ball socket groove, The length of R/2 of the first ball socket groove arranged on the turning shaft and the second ball socket groove arranged on the second casing are staggered, three-dimensional flow is produced through the first ball socket groove and the second ball socket groove, and is subjected to comprehensive effects such as shearing, peeling, coordination, kneading, etc., so that the material is fully mixed.

Preferably, a dispersing plate is arranged between the conveying area and the mixing area, the dispersing plate is sleeved on the outer side wall of the turning shaft, and the dispersing plate is provided with dispersing plates from right to left. The diameter of the dispersion holes on the side of the conveying area is larger than that on the side of the mixing area, so that the mixture is further mixed and the uniformity of mixing is increased, while the diameter of the dispersion holes is located on the side of the conveying area. The pore size larger than that on one side of the mixing area can prevent backflow of the material entering the mixing area.

Preferably, the outer side of the tower body is sequentially provided with an electric heating wire layer and a thermal insulation layer, which can heat and maintain the tower body and ensure that the materials can be fused.

The second technical purpose of the present invention is achieved through the following technical solutions:

A coating, comprising the above-mentioned modified polyamide wax for coating.

The coating of the present invention, comprising the modified polyamide wax of the present invention, has good dispersibility, anti-settling and anti-sagging properties, and better anti-sagging performance.

Preferably, the coating of the present invention comprises, in parts by weight, 40-55 parts by weight of epoxy modified silicone resin, 10-15 parts by weight of fluorocarbon elastic emulsion, 0.5-5 parts by weight of modified polyamide wax, and 1-3 parts by weight of synthetic lithium soapstone, 1-4 parts by weight of dispersant, 1-4 parts by weight of film-forming aid, 0.3-3 parts by weight of defoamer, 0.3-3 parts by weight of leveling agent, 0.1-1 part by weight of thickener, 40-48 parts by weight of deionized water;

the synthetic lithium soapstone is prepared by adding fumed silica, cellulose ether, biopolysaccharide, polypropylene staple fiber and aqueous fluorocarbon solution to the lithium soapstone; the mass ratio of the synthetic lithium soapstone, fumed silica, cellulose ether, biopolysaccharide, polypropylene staple fiber and aqueous fluorocarbon solution is 100:1:1:1:1:1.

The present invention prepares the modified polyamide wax and adjusts the viscosity of the lithium soapstone by a specific method, and synthetic lithium soapstone by modification, so that it has a certain viscosity, the viscosity and dispersibility of the coating can be adjusted, thereby helping to prepare and form an environmentally friendly coating with good product stability. In the present invention, by adding fumed silica, cellulose ether, biological polysaccharide, polypropylene staple fiber and aqueous fluorocarbon solution to the lithium soapstone, due to the capillary action of the fiber structure and the regulating action of fumed silica and biological polysaccharide, the further adjust the viscosity and dispersibility of the modified synthetic lithium soapstone, so as to adjust the viscosity and system stability of the coating, so that the water in the slurry is evenly distributed. The leveling, stability and sag resistance of the coating system are improved by the special intercalation and interface barrier function of the synthetic lithium soapstone protective glue.

To sum up, the present invention has the following beneficial effects:
1. The present invention forms the first complex by first performing physical compounding with the material in step S2, and then carrying out chemical modification in step S3 and the solid content control of step S4, so as to prepare a modified polyamide wax for coating with both dispersion and anti-settling and anti-sagging properties
2. The inventor found that, by adding organic amine, organic solvent and the second composite modifier in the first complex generated in step S2, after mixing uniformly and heating the reaction, it helps to improve the dispersion and anti-settling and anti-sagging properties of modified polyamide waxes for coatings. Moreover, it is conducive to the solid content control of step S4, which may be due to the formation of a block polymer model through the above proportioning and preparation process, the modified polyamide wax for the coating was modified with a chain segment, introduced new functional groups, and at the same time improved its dispersibility and anti-settling and anti-sagging properties through a specific modified polyamide wax preparation device;
3. The present invention fully stirs the material added to the tower body by moving the up-and-down moving stirring mechanism to fully stir, and then enters the secondary stirring mechanism through the discharge port to carry out further mixing, so that the deionized water and the first intermediate modifier are thoroughly fused, thereby improving the dispersion of the final product, and then the product is made to be conveyed while being cooled by cooling and conveying mechanism, and finally cooled to room temperature, and the final product is obtained, time is saved, and the dispersion and productivity of modified polyamide wax are improved;
4. In the present invention, the deionized water enters the connecting rod through the water inlet telescopic tube, and then sprays into the interior of the first intermediate modifier through the water outlet, while the stirring rod keeps rotating, so that the deionized water can be fully exposed to the stockpile, which accelerates the efficiency of stirring and saves manpower and time
5. The present invention telescopes through the push rod end of the hydraulic push rod, drives the fixed box to move up and down, drives the up and down movement of the connecting rod, drives the up and down movement of the stirring rod, rotates the stirring motor simultaneously, drives the driving gear to rotate, thereby the connecting rod rotates, thereby drives the stirring rod to rotate, makes the stirring mechanism move up and down while rotating and stirring, stirring is sufficient, the stirring time is saved simultaneously, and the sag resistance and stirring efficiency of the modified polyamide wax are improved;
6. In the present invention, through the connection between the water outlet and the heating box, deionized water can be selected for the cooling water, so that the deionized water can be used as cooling water. At the same time, the deionized water after use can absorb heat and achieve preliminary heating. After that, the deionized water is heated by the heating box for the second time, and then it can be used as a raw material to be stirred with the first intermediate modifier, so that the deionized water can be fully used, and the reuse of resources and the purpose of energy saving are realized and the economic benefits are improved;
7. The present invention prepares the modified polyamide wax and adjusts the viscosity of the lithium soapstone by a specific method. By modifying the synthetic lithium soapstone to make it have a certain viscosity, the viscosity and dispersibility of the coating can be adjusted, thereby helping to prepare the product. Environmentally friendly paint with good stability. In the present invention, by adding fumed silica, cellulose ether, biological polysaccharide, polypropylene staple fiber and aqueous fluorocarbon solution to the lithium soapstone, due to the capillary action of the fiber structure and the regulating action of fumed silica and biological polysaccharide, the Further adjust the viscosity and dispersibility of the modified synthetic lithium soapstone, so as to adjust the viscosity and system stability of the coating, so that the water in the slurry is evenly distributed. The leveling, stability and sag resistance of the coating system are improved by the special intercalation and interface barrier function of the synthetic lithium soapstone protective glue.

### BRIEF DESCRIPTION OF DRAWINGS

FIG. 1 is a graph showing the comparison of the sag resistance of coatings without adding water-based polyamide wax and adding different water-based polyamide waxes with time;

FIG. 2 is the overall schematic diagram of the preparation device of the modified polyamide wax for coating of the present invention;

FIG. 3 is the invention FIG. 2A magnified schematic diagram of A;

FIG. 4 is a schematic diagram of the plug core of the anti-blocking mechanism of the present invention after being punched out;

FIG. 5 is the invention FIG. 2 The enlarged schematic diagram of B;

FIG. 6 is a schematic diagram of the connection between the connecting rod and the water inlet telescopic tube of the present invention;

FIG. 7 is a schematic diagram of the stirring rod of the present invention.

### DETAILED DESCRIPTION OF THE EMBODIMENTS

### Example 1

A preparation process of modified polyamide wax for coating, comprising the following steps:
S1, raw material ratio: the raw materials include water-based polyamide wax, water-based polyurethane, polyoxyethylene monostearate, the first composite modifier, organic amine, organic solvent, the second composite modifier, and deionized water;

The proportions of each component are:
20 parts of water-based polyamide wax;
3 parts of water-based polyurethane,
1 part of polyoxyethylene monostearate,
1 part of the first composite modifier,
4 parts of organic amines,
8 parts of organic solvent,
1 part of the second composite modifier,
100 parts of deionized water;
S2, firstly mix and disperse water-based polyamide wax, water-based polyurethane, polyoxyethylene monostearate and the first composite modifier in proportion to obtain the first complex;
S3, adding an organic amine, an organic solvent and the second composite modifier to the first complex to mix uniformly, and the temperature is raised to 100-120° C. until the water-based polyamide wax is completely dissolved to obtain the first intermediate modifier;
S4, deionized water is heated up, slowly added to the first intermediate modifier, the stirring speed is controlled, and the temperature is cooled to room temperature to obtain a modified polyamide wax for coating.

The first composite modifier includes a mixture of water-based polyethylene wax, cellulose, xanthan gum and water-based bentonite in a mass ratio of 4:3:2:1;

The second composite modifier includes polyetheramine and carbonamide mixed in a mass ratio of 1:1.

Organic amines are selected from one or more of fatty amines, alcohol amines, amides, and aromatic amines; organic solvents are selected from one or more of propylene glycol monomethyl ether, propylene glycol monobutyl ether, dipropylene glycol methyl ether, and dipropylene glycol butyl ether.

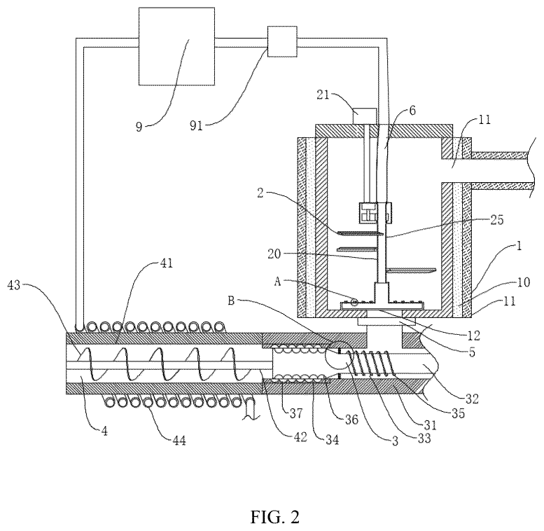

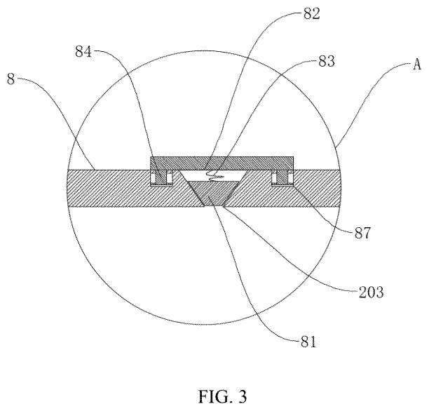

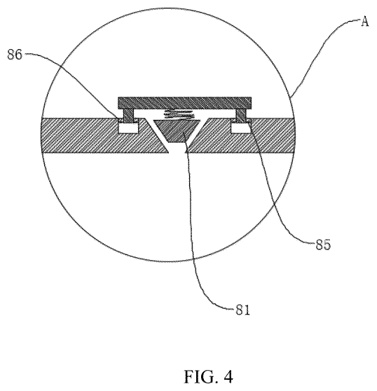

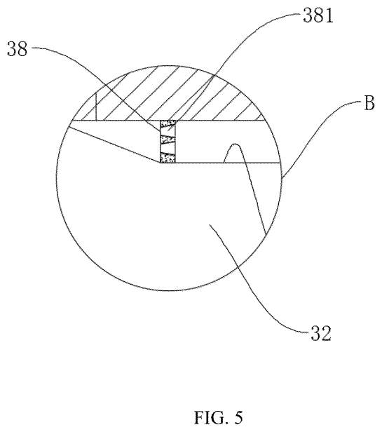

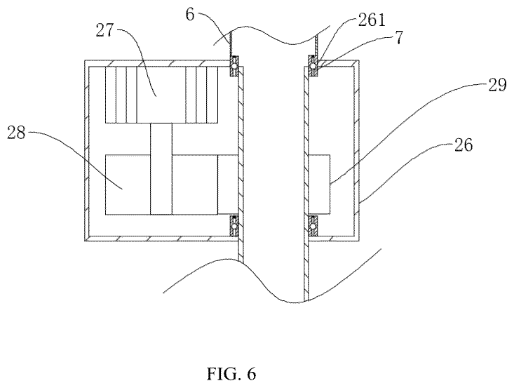

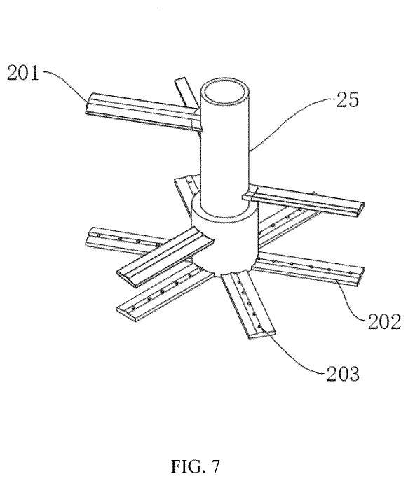

As shown in FIG. 2-7, the preparation device of modified polyamide wax includes a tower body 1, a up-and-down moving stirring mechanism 2, a secondary stirring mechanism 3, a cooling and conveying mechanism 4, a discharge valve 5, and the top of the side wall of the tower body 1 is provided with the feed port 11, the bottom of the tower body 1 is provided with the discharge port 12, the discharge valve 5 is set on the discharge port 12, the up-and-down moving stirring mechanism 2 is set in the tower body 1, and the secondary stirring mechanism 3 is set on the discharge valve 5, the cooling and conveying mechanism 4 is located at the end of the secondary stirring mechanism 3, and up-and-down moving stirring mechanism 2 includes the hydraulic push rod 21, the connecting rod 25, the hollow fixed box 26, the stirring motor 27, the driving gear 28, driven gear 29, the stirring rod 20, the sealing bearing 7, the hydraulic push rod 21 is set on the top of the tower body 1, the fixed box 26 is fixedly connected with the push rod end of the hydraulic push rod 21, the stirring motor 27 is set in the fixed box 26, the driving gear 28 is arranged on the output shaft of the stirring motor 27, the driven gear 29 is meshed with the driving gear 28, the connecting rod 25 passes through the driven gear 29 and the fixed 26 box and is fixedly connected with the driven gear 29, and the mounting hole 261 is opened from the upper surface to the lower surface of the fixed box 26, the sealing bearing 7 is fixed on the mounting hole 261, the inner ring of the sealing bearing 7 is fixedly connected with the outer side wall of the connecting rod 25, the stirring rod 20 is arranged on the connecting rod 25, and the stirring rod 20 includes the first stirring rod 201 and the second stirring rod 202, the first stirring rod 201 is located on the side wall of the connecting rod 25, the second stirring rod 202 is located at the bottom of the connecting rod 25, and the second stirring rod 202 is evenly distributed along the axial direction of the connecting rod 25, the first stirring rod 201 is inclined downward by 10-15°, the interior of the connecting rod 25 is a hollow structure, the interior of the second stirring rod 202 is a hollow structure, and the second stirring rod 202 and the connecting rod 25 are connected to each other. The tops of the two stirring rods 202 are provided with water outlet hole 203. The outer ring of the sealing bearing 7 is fixedly connected with the water inlet telescopic tube 6. The other end of the water inlet telescopic tube 6 extends outside the tower body 1. The cooling and conveying mechanism 4 includes the first casing 41, the rotating shaft 42, the spiral blade 43, the cooling coil 44, the rotating shaft 42 is arranged in the first casing 41, the spiral blade 43 is wound on the rotating shaft 42, and the cooling coil 44 is wound around the first casing 41 on the outer side wall.

The water outlet hole 203 is provided with the anti-blocking mechanism 8, and the anti-blocking mechanism 8 includes the plug core 81, the cover plate 82, the first compression spring 83, the limit rod 84, the limit block 85, the limit ring 86, the limit groove 87 is provided on both sides of the water outlet hole 203, the cover plate 82 is covered on the water outlet hole 203, the first compression spring 83 is arranged at the bottom of the cover plate 82, and the plug core 81 is arranged at the bottom of the first compression spring 83 and is located at the water outlet, in the water outlet hole 203, the limit ring 86 is set at the notch of the limit groove 87, the limit rod 84 passes through the limit ring 86 and is fixedly connected with the bottom of the cover plate 82, and the limit block 85 is set at the bottom of the limit rod 84.

The secondary stirring mechanism 3 includes a second casing 31 and a turning shaft 32 able to rotate in the second casing 31. The end of the turning shaft 32 is fixedly connected to the starting end of the rotating shaft 42. The turning shaft 32 includes from right to left. There are the conveying area 33 and a mixing area 34, the conveying area 33 is the main screw 35, the first ball socket groove 36 is opened at the turning shaft of the mixing area 34, the interior of the second casing 31 is provided with the second ball socket groove 37 fitted with the first ball socket groove 36, the first ball socket groove 36 arranged on the turning shaft 32 is R/2 length away from the second ball socket groove 37 arranged on the adjacent second casing, the dispersing plate 38 is arranged between the conveying area 33 and the mixing area 34. The dispersing plate 38 is sleeved on the outer side wall of the turning shaft 32. The dispersing plate 38 is provided with a dispersing hole 381 from right to left. The aperture on the side of the conveying area 33 is larger than the aperture on the side of the mixing area 34, and the outer side of the tower body 1 is provided with a heating wire layer 10 and the feed port 11 in sequence.

Working principle: the first intermediate modifier is transported into the tower body 1 through the feed port. During the transportation process, the pipeline needs to be insulated, and then the heated deionized water passes through the booster pump, and then expands and contracts through the inlet water. The water inlet telescopic tube enters the connecting rod 25, sprays out from the water outlet hole 203 of the second stirring rod 202 and enters the interior of the first intermediate modifier, while the stirring motor 27 rotates, driving the driving gear 28 to rotate, and driving the driven gear 29 to rotate, Therefore, the connecting rod 25 is driven to rotate, the stirring rod 25 is driven to rotate, and the first intermediate modifier and the deionized water are stirred and fused. Due to the installation of the sealing bearing 7, the water inlet telescopic tube 6 will not rotate. At the same time, the hydraulic push rod 21 drives the fixed box 26 to move up and down, thereby driving the stirring rod 25 to move up and down, so that the first intermediate modifier and the deionized water are fully mixed, and the dispersion of the modified polyamide wax is improved. After the stirring is completed, the discharge valve 5 is opened to enter the secondary stirring mechanism 3, and the main screw 35 of the secondary stirring mechanism 3 is transported to the dispersing plate 38, and the mixture is further mixed to increase the uniformity of mixing. The first ball socket groove 36 and the second ball socket groove 37 generate a three-dimensional flow, and are subjected to the combined action of shearing, peeling, coordination, kneading, etc., so that the materials are fully mixed, so that the part that is not stirred in the tower body will not be stirred until the second time. The secondary stirring mechanism 3 can be thoroughly mixed and then transported through the cooling and conveying mechanism 4, and the product is cooled to normal temperature through the cooling coil 44, which improves the stirring efficiency and improves the dispersibility of the product.

### Example 2

The difference from the above example 1 is S1, and the ratio of each component is:
30 parts of water-based polyamide wax,
5 parts of water-based polyurethane,
3 parts of polyoxyethylene monostearate,
3 parts of the first composite modifier,
6 parts of organic amines,
20 parts of organic solvent,
3 parts of the second composite modifier,
100 parts of deionized water;

### Example 3

The difference from the above example 1 is S1, and the ratio of each component is:
25 parts of water-based polyamide wax,
4 parts of water-based polyurethane,
2 parts of polyoxyethylene monostearate,
2 parts of the first composite modifier,
5 parts of organic amines,
10 parts of organic solvent,
2 parts of the second composite modifier,
100 parts of deionized water;

### Example 4

Different from the above example 1, the second composite modifier also includes 3-isocyanatomethylene-3,5,5-trimethylcyclohexylisocyanate, wherein, 3-isocyanatomethylene-3,5,5-trimethylcyclohexylisocyanate and polyetheramine is 1:1. The water outlet of the cooling coil 44 is connected to the heating box 9 through a pipeline, the outlet of the heating box 9 is connected to the pump 91 through a pipeline, and the water outlet of the pump 91 is connected to the water inlet telescopic tube 6 through a pipeline, Through the connection between the water outlet and the heating box 9, deionized water can be selected for the cooling water, so that the deionized water can be used as cooling water. The heating box heats the deionized water for the second time, and then it can be used as a raw material for stirring with the first intermediate modifier, so that the deionized water can be fully used, the resource reuse is realized, the purpose of energy saving is realized, and the economy benefit is improved.

### Comparative Example 1

The difference from the above example 1 is S1, and the ratio of each component is:
40 parts of water-based polyamide wax,
2 parts of water-based polyurethane,
1 part of polyoxyethylene monostearate,
5 parts of the first composite modifier,
2 parts of organic amines,
6 parts of organic solvent,
0.5 part of the second composite modifier,
100 parts of deionized water;

The preparation device of the modified polyamide wax did not adopt the preparation device of Example 1.

### Application Example 1

A coating, comprising the modified polyamide wax for coating of Example 1. Specifically, the coating comprises, in parts by weight, 40 parts by weight of epoxy modified silicone resin, 10 parts by weight of fluorocarbon elastic emulsion, 0.5 part by weight of modified polyamide wax, 1 part by weight of synthetic lithium soapstone, 1 part by weight of dispersant, 1 part by weight of film-forming aid, 0.3 part by weight of defoamer, 0.3 part by weight of leveling agent, 0.1 part by weight of thickener, and 48 parts by weight of deionized water;
the synthetic lithium soapstone is prepared by adding fumed silica, cellulose ether, biopolysaccharide, polypropylene staple fiber and aqueous fluorocarbon solution to the lithium soapstone; the mass ratio of the synthetic lithium soapstone, fumed silica, cellulose ether, biopolysaccharide, polypropylene staple fiber and aqueous fluorocarbon solution is 100:1:1:1:1:1.

### Application Example 2

A coating, comprising the modified polyamide wax for coating of Example 2. Specifically, the coating comprises, in parts by weight, 55 parts by weight of epoxy modified silicone resin, 15 parts by weight of fluorocarbon elastic emulsion, 5 parts by weight of modified polyamide wax, 3 parts by weight of synthetic lithium soapstone, 4 parts by weight of dispersant, 4 parts by weight of film-forming aid, 3 parts by weight of defoamer, 3 parts by weight of leveling agent, 1 part by weight of thickener, and 40 parts by weight of deionized water;
the synthetic lithium soapstone is prepared by adding fumed silica, cellulose ether, biopolysaccharide, polypropylene staple fiber and aqueous fluorocarbon solution to the lithium soapstone; the mass ratio of the synthetic lithium soapstone, fumed silica, cellulose ether, biopolysaccharide, polypropylene staple fiber and aqueous fluorocarbon solution is 100:1:1:1:1:1.

### Application Example 3

A coating comprising the modified polyamide wax for coating of Example 3. Specifically, the coating comprises, in parts by weight, 45 parts by weight of epoxy modified silicone resin, 12 parts by weight of fluorocarbon elastic emulsion, 1 part by weight of modified polyamide wax, 2 parts by weight of synthetic lithium soapstone, 3 parts by weight of dispersant, 2 parts by weight of film-forming aid, 2 parts by weight of defoamer, 2 parts by weight of leveling agent, 0.8 parts by weight of thickener, and 44 parts by weight of deionized water;
the synthetic lithium soapstone is prepared by adding fumed silica, cellulose ether, biopolysaccharide, polypropylene staple fiber and aqueous fluorocarbon solution to the lithium soapstone; the mass ratio of the synthetic lithium soapstone, fumed silica, cellulose ether, biopolysaccharide, polypropylene staple fiber and aqueous fluorocarbon solution is 100:1:1:1:1:1.

### Application Example 4

The same as application example 3, the difference is that the modified polyamide wax used for the coating prepared in example 4 is used as the modified polyamide wax.

### Application Comparative Example 1

The same as Application Example 3, the difference is that the modified polyamide wax used for the coating prepared in Comparative Example 1 is used as the modified polyamide wax.

### Application Comparative Example 2

The same as Application Example 3, the difference is that the coating comprises 65 parts by weight of epoxy modified silicone resin, 10 parts by weight of fluorocarbon elastic emulsion, 0.1 part by weight of modified polyamide wax, and 0.5 part by weight of synthetic lithium soapstone. The rest are the same as in Example 3.

Performance testing experiment of modified polyamide wax for coatings:

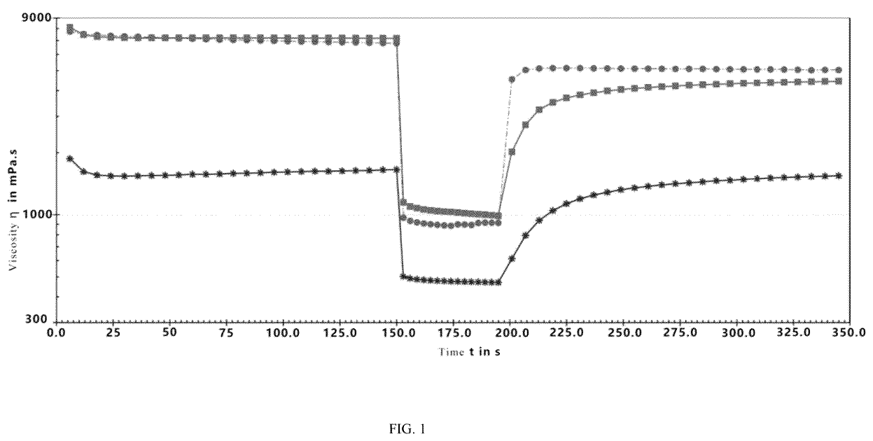

As shown in FIG. 1, curve 1 is the rheological curve diagram of the paint without adding water-based polyamide wax, curve 2 is the paint added with existing foreign water-based polyamide wax, and curve 3 is added with the modified water-based polyamide wax of Example 1 of the present invention of paint.

In order to obtain better dispersion performance, generally, the aqueous polyamide wax paste is prepared into a 20% or 30% pre-gel (depending on the difficulty of dispersion). Since the modified polyamide waxes prepared by the formulations and preparation methods of the present application in Examples 1 to 4 have relatively better dispersion properties, the modified polyamide waxes of Examples 1 to 4 were all prepared into 30% pre-gel; The modified polyamide wax in the proportion is prepared into 20% pre-gel due to its larger consistency.

The fineness, sag resistance, thixotropic index and 24 h anti-sinking effect were measured. In order to compare the effects of water-based polyamide waxes, a coating without water-based polyamide wax rheological additives was added as a comparative example. The detailed results See Table 1.

in:

The fineness test is carried out in accordance with the national standard GB/T 6753.1˜2007 “Determination of the fineness of grinding of paints, varnishes and printing inks”.

The sag resistance is in accordance with the national standard GB/T9264˜88 “Determination of paint sag”. The instrument used is the Item ASM˜4 type anti-sag tester in Leneta Anti-Sag Meter, and the sag tester is used to test the color paint. The sag of the film is measured, and the thickness of the coating film that is placed vertically and does not flow to the next thickness strip is the value that does not sag. The larger the thickness value, the less likely it is to sag.

The anti-settling test method is as follows. After the fineness test, the paint is placed in a 100 ml graduated cylinder, and placed in a 50° C. oven for 24 hours to observe its anti-settling effect. The reading is expressed as a percentage.

TABLE 1

| | | | | | | Application | Application |
|---|---|---|---|---|---|---|---|
| | | Application | Application | Application | Application | Comparative | Comparative |
| Item | Performance | Example 1 | Example 2 | Example 3 | Example 4 | Example 1 | Example 2 |
| 1 | Scraper | 19 | 19 | 18 | 16 | 20 | 20 |
| | fineness (μm) | | | | | | |
| 2 | Maximum | 550 | 550 | 550 | 600 | 500 | 500 |
| | film thickness | | | | | | |
| | without | | | | | | |
| | sagging | | | | | | |
| | before heat | | | | | | |
| | storage (μm) | | | | | | |
| 3 | Maximum | 550 | 550 | 550 | 600 | 450 | 450 |
| | film thickness | | | | | | |
| | without | | | | | | |
| | sagging after | | | | | | |
| | heat storage | | | | | | |
| | (μm) | | | | | | |
| 4 | Anti-settling | 98 | 97 | 98 | 99 | 85 | 92 |
| | percentage | | | | | | |
| | within 24 | | | | | | |
| | hours (%) | | | | | | |
| 5 | Thixotropic | 6.58 | 6.47 | 6.62 | 6.75 | 5.13 | 5.35 |
| | index | | | | | | |

The above experimental data show that:
1. From the experimental data of Examples 1-4, Comparative Example 1, Application Examples 1-4 and Application Comparative Example 1, it can be seen that the modified water-based polyamide wax prepared by embodiment 1-4 performs better in the rheological properties of the coating, which is reflected in the fineness of the scraper, anti-sagging, 24 h anti-sinking and thixotropic index, thus indicating that the dispersion performance and anti-sag performance of the modified water-based polyamide wax prepared in embodiment 1-4 are better than those of the pair ratio 1, Wherein the dispersion performance of the modified water-based polyamide wax of embodiment 4 in the coating is better than that of embodiment 1-3;
2. From the experimental data of Examples 1-4, Comparative Example 1, Application Examples 1-4 and Application Comparative Examples 1 and 2, it can be seen that the application embodiment 1-4 and the application of the proportion 1 and 2 that the storage stability, anti-settling performance and anti-sag performance of the coating system prepared are better.

Technicians in the relevant field are allowed to make modifications that do not contribute creatively to this embodiment as required after reading this specification. Nevertheless, as long as it remains within the scope of the claims of the present invention, it will be protected by the patent law.

What is claimed is:

1. A preparation technology of modified polyamide wax for coating, it is characterized by containing the following steps:
s1, raw material ratio: the raw materials include water-based polyamide wax, water-based polyurethane, polyoxyethylene monostearate, the first composite modifier, organic amine, organic solvent, the second composite modifier, and deionized water;
the proportions of each component are:
20-30 parts of water-based polyamide wax;
3-5 parts of water-based polyurethane,
1-3 parts of polyoxyethylene monostearate,
1-3 parts of the first composite modifier,
4-6 parts of organic amines,
8-20 parts of organic solvent,
1-3 parts of the second composite modifier,
100 parts of deionized water;
the first composite modifier includes water-based polyethylene wax, cellulose, xanthan gum and water-based bentonite mixed in a mass ratio of 4:3:2:1;
the second composite modifier includes polyetheramine and carbonamide mixed in a mass ratio of 1:1;
the organic amine is selected from one or more of fatty amines, alcohol amines, amides, and aromatic amines; the organic solvent is selected from one or more of propylene glycol monomethyl ether, propylene glycol monobutyl ether, dipropylene glycol methyl ether, and dipropylene glycol butyl ether;
s2, firstly mix and disperse water-based polyamide wax, water-based polyurethane, polyoxyethylene monostearate and the first composite modifier in proportion to obtain the first complex;
s3, adding an organic amine, an organic solvent and the second composite modifier to the first complex to mix uniformly, and the temperature is raised to 100-120° C. until the water-based polyamide wax is completely dissolved to obtain the first intermediate modifier;
s4, heating the deionized water, slowly adding it to the first intermediate modifier, controlling the stirring speed, and cooling to room temperature to obtain the modified polyamide wax for coating;
a preparing device for preparing modified polyamide wax includes a tower body (1), a up-and-down moving stirring mechanism (2), a secondary stirring mechanism (3), a cooling and conveying mechanism (4), a discharge valve (5), the top of the side wall of the tower body (1) is provided with the feed port (11), the bottom of the tower body (1) is provided with the discharge port (12), and the discharge valve (5) is arranged on the discharge port (12), the up-and-down moving stirring mechanism (2) is arranged in the tower body (1), and the secondary stirring mechanism (3) is arranged at the discharge port of the discharge valve (5), the cooling and conveying mechanism (4) is arranged at the end of the secondary stirring mechanism (3); the up-and-down moving stirring mechanism (2) includes the hydraulic push rod (21), the connecting rod (25), the fixed box (26) with a hollow interior, the stirring motor (27), the driving gear (28), the driven gear (29), the stirring rod (20), the sealing bearing (7), the hydraulic push rod (21) is provided on the tower body (1), the fixed box (26) is fixedly connected with the push rod end of the hydraulic push rod (21), the stirring motor (27) is arranged in the fixed box (26), the driving gear (28) set on the output shaft of the stirring motor (27), the driven gear (29) is meshed with the driving gear (28), and the connecting rod (25) passes through the driven gear (29) and the driving gear (28), the fixed box (26) is fixedly connected with the driven gear (29), the upper surface to the lower surface of the fixed box (26) is provided with the mounting hole (261), and the sealing bearing (7) is fixed in the mounting hole (261), the inner ring of the sealing bearing (7) is fixedly connected with the outer side wall of the connecting rod (25), and the stirring rod (20) is provided on the connecting rod (25);
the stirring rod (20) includes the first stirring rod (201) and the second stirring rod (202), the first stirring rod (201) is located on the side wall of the connecting rod (25), the second stirring rod (202) is located at the bottom of the connecting rod (25), the second stirring rod (202) is evenly distributed in the axial direction of the connecting rod (25), and the first stirring rod (201) slope down 10˜15°;
the interior of the connecting rod (25) is a hollow structure, the interior of the second stirring rod (202) is a hollow structure, the second stirring rod (202) and the connecting rod (25) communicate with each other, and each the top of the second stirring rod (202) is provided with the water outlet hole (203), and the outer ring of the sealing bearing (7) is fixedly connected with the water inlet telescopic tube (6), the other end of the water inlet telescopic tube (6) extends outside the tower body (1); the cooling and conveying mechanism (4) includes the first casing (41), the rotating shaft (42), the spiral blade (43), the cooling coil (44), the rotating shaft (42) is arranged in the first casing (41), the spiral blade (43) is wound on the rotating shaft (42), and the cooling coil (44) is wound on the outer side wall of the first casing (41);
the water outlet end of the cooling coil (44) is connected to the heating box (9) through a pipeline, the outlet of the heating box (9) is connected to the pump (91) through a pipeline, and the water outlet of the pump (91) is connected to the water inlet telescopic tube (6) by a pipeline;
the secondary stirring mechanism (3) includes the second casing (31) and the turning shaft (32) that can be rotated in the second casing (31), and the end of the turning shaft (32) is connected with the starting end of the rotating shaft (42) is fixedly connected, the turning shaft (32) includes the conveying area (33) and the mixing area (34) from right to left, and the conveying area (33) is the main screw (35), the first ball socket groove (36) is provided at the turning shaft of the mixing area (34), and the inside of the second casing (31) is provided with the first ball socket groove (36) to cooperate with each other the second ball socket groove (37), the first ball socket groove (36) arranged on the turning shaft (32) is dislocated R/2 length from the second ball socket groove (37) arranged on the adjacent second casing.

2. The preparation technology of modified polyamide wax for coating according to claim 1, it is characterized by:
the second composite modifier also includes 3-isocyanatomethylene-3,5,5-trimethylcyclohexylisocyanate, the 3-isocyanatomethylene-3,5,5-trimethylcyclohexylisocyanate to polyetheramine was 1:1.

3. The preparation technology of modified polyamide wax for coating according to claim 2, it is characterized by:
the water outlet hole (203) is provided with the anti-blocking mechanism (8), the anti-blocking mechanism (8) includes the plug core (81), the cover plate (82), the first compression spring (83), the limit rod (84), the limit block (85), the limit ring (86), the two sides of the water outlet hole (203) are provided with oppositely arranged limit groove (87), and the cover plate (82) covers the on the water outlet hole (203), the first compression spring (83) is arranged at the bottom of the cover plate (82), and the plug core (81) is arranged at the bottom of the first compression spring (83) and located in the water outlet hole (203), the limit ring (86) is provided at the notch of the limit groove (87), and the limit rod (84) passes through the limit ring (86) and is fixedly connected with the bottom of the cover plate (82), and the limit block (85) is arranged on the bottom of the limit rod (84).

4. A coating, comprising the modified polyamide wax prepared by the preparation process of a modified polyamide wax for coating according to any one of the above claim 1; the coating comprises 40-55 parts by weight of epoxy modified silicone resin, 10-15 parts by weight of fluorocarbon elastic emulsion, 0.5-5 parts by weight of modified polyamide wax, 1-3 parts by weight of synthetic lithium soapstone, 1-4 parts by weight of dispersant, 1-4 parts by weight of film-forming aid, 0.3-3 parts by weight of defoamer, 0.3-3 parts by weight of leveling agent, 0.1-1 parts by weight of thickener, and 40-48 parts by weight of deionized water;
the synthetic lithium soapstone is prepared by adding fumed silica, cellulose ether, biopolysaccharide, polypropylene staple fiber and aqueous fluorocarbon solution to the lithium soapstone; the mass ratio of the synthetic lithium soapstone, fumed silica, cellulose ether, biopolysaccharide, polypropylene staple fiber and aqueous fluorocarbon solution is 100:1:1:1:1:1.
